(19) United States
(12) Patent Application Publication
(10) Pub. No.: US 2023/0309073 A1
(43) Pub. Date: Sep. 28, 2023

(54) System and Method for Television White Space Network Communication

(71) Applicant: 6Harmonics Inc., Ottawa (CA)

(72) Inventor: Shinguan Wu, Ottawa (CA)

(21) Appl. No.: 18/189,199

(22) Filed: Mar. 23, 2023

Related U.S. Application Data
(60) Provisional application No. 63/323,228, filed on Mar. 24, 2022.

(51) Int. Cl. H04W 72/0453; H04W 16/14

(52) U.S. Cl. CPC H04W 72/0453; H04W 16/14

(57) ABSTRACT

A method and system are disclosed having a commercially available integrated circuit modified for encoding data at a second lower bandwidth compared to a bandwidth typically used to encode data from the commercially available integrated circuit. The modified commercially available integrated circuit provides an output signal at an output port thereof for being down converted to a frequency band within the TVWS band and having data encoded therein with a bandwidth supported in the TVWS band.

### FIELD OF THE INVENTION

The invention relates to wireless networking and more particularly to wireless networks formed within television white space bands.

### BACKGROUND

When wireless communications was invented, an electrical analogue representation of a sound was amplified and used to drive an antenna. From the antenna, a signal was radiated to a distant antenna that received this analogue radiated field. The received signal was then amplified and provided to a speaker. Someone speaking in one location could be heard from a speaker at a distant location.

This form of communication allowed for nearly instantaneous communication over very long distances. Unfortunately, several problems were known to exist in wireless communication such as signal degradation, the ability of anyone to listen to any signal, signal interreference, etc. Effectively, the first radios and televisions relied on a simple analogue transmission process that is easily discernable based on signals containing static and being received by many listeners nearly simultaneously.

Over the following century, researchers managed to digitise the sounds, allowing them to encode a digital signal for many purposes. For example, voice communications can be easily digitised into 64 Kb channels allowing for many voice signals to be transmitted interleaved within a same radiated signal. The digital content of each digital signal could be obfuscated, encrypted, to prevent interception. Also, the digital signal could be encoded for reconstruction at a receiver allowing for crystal clear reception even in the presence of interference and noise.

Unfortunately, as the ability to modify digital data for being transmitted was further developed, the circuitry to do so became more complicated and therefore best suited to mass production. A walkie talkie relies on a very simple circuit to transform voice into a radiated signal and to transform a received signal back into sound. Circuit simplicity means that such a device is inexpensive to design and quality assurance costs/testing are reasonable processes.

In contrast, when designing a new encryption technology for mass implementation, the math for the transform is developed, then it is verified by experts, then it is implemented and tested, then it is provided to the community at large for security verification where thousands of experts try to circumvent the encryption technology, and finally it is standardised. Then, once standardised, it is designed into circuits, which themselves then require quality assurance testing to make sure that (a) they are secure and (b) that they work in accordance with the standard.

Overall, the cost for implementing a modern encryption standard within an integrated circuit is very high, for implementing an encryption process in software that remains fully secure is also quite high, for implementing a version of an encryption standard in software with limited security is high, etc. For this reason, security software and integrated circuits are typically designed by a few enterprises and reused by others.

Analogously, data correction encoding standards are also time-consuming, complex and expensive to implement.

For this reason, it is very common that only a few companies dominate communication with any given communication methodology and, only a few companies supply components to those who dominate in communications technologies.

It would be advantageous to provide a robust, less failure prone, lower maintenance solution that does not require a very high design cost in order to support wireless communication.

### SUMMARY

In accordance with embodiments of the invention there is provided a method comprising: selecting a first communication standard for supporting communication between at least one transmitter and at least one receiver, the first communication standard supporting a first data bandwidth; determining an encoding of first data within a first signal in accordance with the first communication standard for providing first encoded data, the first encoded data for being down converted into a second signal within a TVWS (television white space) band, the first encoded data having a bandwidth for having the first encoded data encoded within the second signal within the TVWS band in accordance with a TVWS standard; selecting a commercially available integrated circuit for use with the first communication standard and for encoding data within an output signal in accordance with the first standard at the first data bandwidth; modifying the commercially available integrated circuit by changing one of registers thereof, microcode thereof, or updatable codes stored therein for modifying encoding performed by the commercially available integrated circuit, the modified encoding for producing a modified output signal encoding data in accordance with the first standard but having encoded therein data at a second other lower bandwidth, the second other lower bandwidth other than a bandwidth supported by the first standard; providing communication data to the commercially available integrated circuit; encoding the communication data within an output signal of the modified commercially available integrated circuit to provide encoded communication data in accordance with the first standard but having encoded therein the encoded communication data at the second other lower bandwidth; providing the output signal from the commercially available integrated circuit to a down converter; down converting the output signal to a second band within the TVWS band to provide a first down converted signal, the first down converted signal having the encoded communication data encoded therein; and providing the first down converted signal for wireless transmission.

In accordance with another aspect of the invention there is provided an integrated circuit comprising: a commercially available integrated circuit for use with a first communication standard and for encoding data within an output signal in accordance with the first standard and having a first data bandwidth, the commercially available integrated circuit modified by changing one of registers thereof, microcode thereof, or updatable codes stored therein for modifying encoding performed by the commercially available integrated circuit, the modified commercially available integrated circuit for producing a modified output signal encoded in accordance with the first standard but having encoded therein data at a second other lower bandwidth, the second other lower bandwidth other than a bandwidth supported by the first standard.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified diagram of two TVWS transceivers;

FIG. 2 is a simplified flow diagram of a high-level method according to an embodiment;

FIG. 3 is a simplified block diagram of a very limited embodiment;

FIG. 4 is a simplified block diagram of a system supporting multiple-channel bandwidths;

FIG. 5 is a simplified flow diagram of a method of modifying registers within a standard conforming networking integrated circuit other than a TVWS standard conforming integrated circuit for a single band communication;

FIG. 6 is a simplified flow diagram of a method of modifying registers within a standard conforming networking integrated circuit other than a TVWS standard conforming integrated circuit for supporting a plurality of different bandwidths of communication;

FIG. 7 is a simplified flow diagram of a method training and using a correlation processor to map registers within a standard conforming networking integrated circuit other than a TVWS standard conforming integrated circuit; and

FIG. 8 is a block diagram of a circuit employing a modified standard conforming networking integrated circuit other than a TVWS standard conforming integrated circuit for encoding a TVWS standard conforming signal.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

TVWS (or “TV white space” or “television white space”) is a portion of the wireless communication spectrum including parts of the VHF and UHF bands initially allocated for television broadcast transmission and spacing therebetween and now unused in some areas, some different TVWS existing in some different geographic areas.

TVWS band is a portion of the RF transmission spectrum allocated for TVWS communication.

Suitably programmed integrated circuit is an integrated circuit that has data stored therein for affecting operation of the integrated circuit making the integrated circuit a suitably programmed integrated circuit.

Commercially available integrated circuit is an integrated circuit that is purchasable from an integrated circuit manufacturer, integrated circuit designer and/or from an electronics parts supplier.

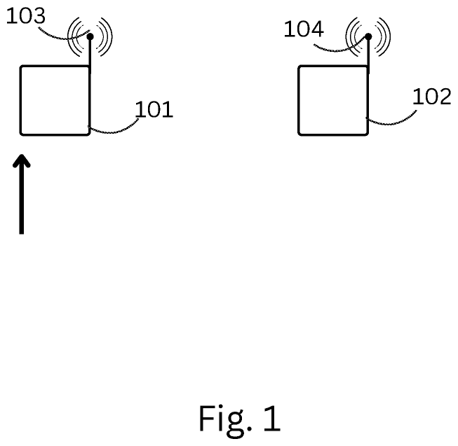

Referring to FIG. 1, shown is a typical TVWS communication network. A transmitter 101 receives data for transmission. In present day TVWS applications in North America, the data provided is a quantity of data at a rate for transmission via a 6 MHz bandwidth wireless channel. Encoding of the data typically assumes some portion of the available bandwidth such that the data for transmission is less than the theoretical maximum amount of data transmissible within a 6 MHz bandwidth.

The received data is digitally encoded and then converted to an analogue signal. Typically, this comprises a carrier signal at a known frequency within the TVWS band having a “digital” signal encoded therein. Effectively, the carrier signal is modified such that when received, small perturbations to the carrier signal are extractable as digital data.

The analogue signal is provided to a radiator circuit 103 including an amplifier that drives an antenna as its load. The antenna radiates the TVWS communication signal.

At the receiving end, the system operates in reverse with a TVWS wireless signal impinging on a radiator circuit 104 comprising an antenna. The antenna induces a small signal within a second transceiver circuit 102 that is provided for filtering and amplification. The amplified signal is then separated—removing the digital portion of the signal form the carrier signal and the digital portion of the signal is decoded, and provided at an output port as digital data—the same as was received at the transmitter.

By selecting reasonable encryption and encoding processes, either known or custom designed, the system is capable of reliably communicating data between the two transceivers 101 and 102, the data encoded on a carrier signal within the TVWS band.

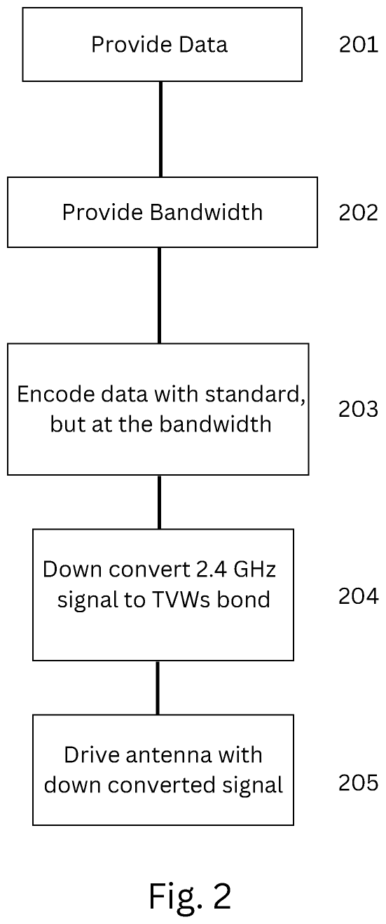

Referring to FIG. 2, shown is a simplified block diagram of an embodiment. Here, a signal is encoded relying on a known standard having a known transmission frequency outside the TVWS band. Data is provided at 201 to a circuit for encoding the data onto an RF carrier signal outside the TVWS band. At 202, a data rate is provided. The data is encoded at the data rate for fitting within data rates of data signals within the TVWS band, which typically provide around 6 MHz of bandwidth in North America, at 203. Once the RF signal is generated, the RF signal is down converted at 204 into the TVWS band without other modifications to the RF signal such that the data encoded within the RF signal outside the TVWS band remains encoded within the down converted RF signal within the TVWS band.

The down converted RF signal is provided to an amplifier for driving an antenna at 205.

Beneficially, this allows TVWS transceivers to benefit from third party protocol chips that do not support TVWS communication but are mass produced to support lower costs and more robust verification and testing. Further beneficially, this allows TVWS communication with the benefits of another protocol supporting data integrity, data security, addressing and networking protocols, broadcasting protocols, etc.

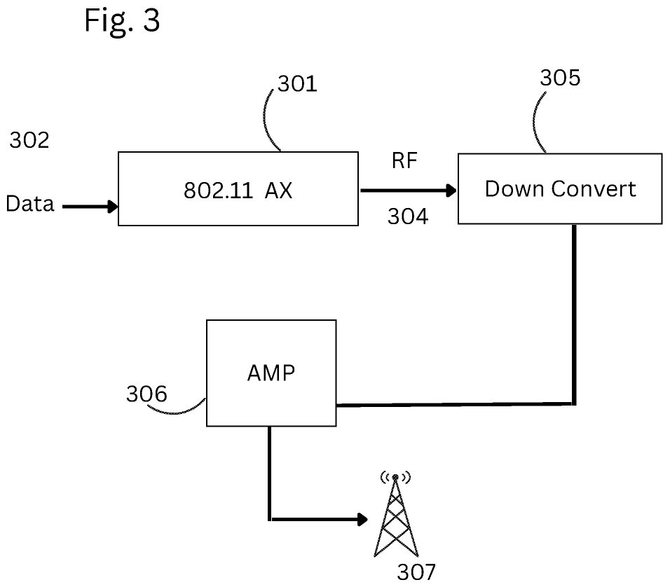

Referring to FIG. 3, shown is a block diagram of a non-functional circuit. Here, an 802.11 ax chip 301 is coupled for receiving data 302 for transmission. The chip encodes the data into an 802.11 channel according to the 802.11 standard; typically, this channel has 22 MHz bandwidth for 802.11 wireless transmission. The data is encoded with error detection/correction information, with addressing information for networking the data and with obfuscation for securing the data.

The encoded data is superimposed on an RF signal 304 at 2.4 GHz or at 5 GHz and provided to down converter 305. Once down converted to a TVWS band, the signal is provided to amplifier 306 which drives antenna 307 to radiate a wireless signal therefrom.

Unfortunately, the data as encoded within channels of 22 MHz on a carrier signal outside the TVWS band, when down converted, results in a significant loss of information because TVWS signal channels have 6 MHz of bandwidth in North America. For example, if the data is encoded within a 22 MHz band, then down converting the RF signal results in 22 MHz of bandwidth being squeezed into 6 MHz, which results in inoperability of the resulting circuit.

As such, a transform is applied to at least one of the 802.11 encoding and the data provided for 802.11 ax encoding to ensure that a signal provided at an output thereof is for being down converted without a loss of data and without corruption of the data. Further, the down converted signal is suitable for use as a TVWS RF signal, for example once filtered with an analogue filter. In some embodiments, the down converted signal is suitable for use as a TVWS RF signal, ready to be provided to an amplifier for driving an antenna, without modification.

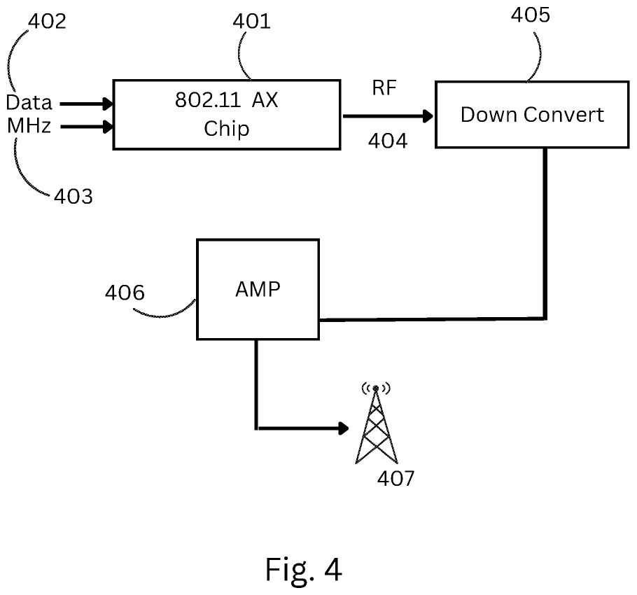

Referring to FIG. 4, shown is a block diagram of a circuit according to an embodiment. Here, an 802.11 ax chip 401 is coupled for receiving data 402 for transmission. The chip also receives a bandwidth selector signal 403 for selecting a bandwidth. For example in North America, the bandwidth signal might select between 6, 12, 18 and 22 MHz bandwidth depending on available adjacent TVWS channels. The chip 401 encodes the data into an 802.11 channel according to the 802.11 standard; typically, this channel has 22 MHz bandwidth for 802.11 wireless transmission. The data is encoded with error detection/correction information, with addressing information for networking the data and with obfuscation for securing the data.

Unfortunately, the data is encoded in channels on a carrier signal outside the TVWS band and down converting the signal results in a significant loss of information. For example, if the data is encoded within a 22 MHz band, then down converting the RF signal results in 20 MHz of bandwidth being squeezed into 6 MHz, which results in a loss of over ⅔ of the information and/or in inoperability of the resulting circuit.

The encoded data is superimposed on an RF signal 404 at 2.4 GHz or at 5 GHz and provided to down converter 405 to down convert the signal into the TVWS band. Once down converted to a TVWS band, the signal is provided to amplifier 406 which drives antenna 407 to radiate a wireless signal therefrom.

As such, a transform is applied to at least one of the 802.11 encoding and the data provided for 802.11 ax encoding to ensure that the RF signal 404 provided at an output port thereof is generated for being directly down converted without a loss of data and without corruption of the data.

In another embodiment, all signals are encoded with a single TVWS channel bandwidth. In North America that would be 6 MHz.

In another embodiment a different 802.11 chip or chipset is employed. In yet another embodiment, a chip for implementing another standard is employed.

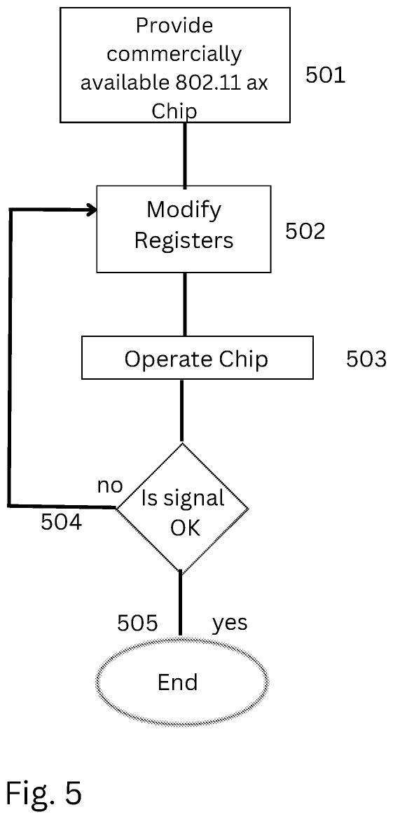

Referring to FIG. 5, shown is a simplified flow diagram of a method for modifying a commercially available wireless networking chip and/or chipset in the form of an 802.11 chip and/or chipset. 802.11ax chips are designed to be tunable for supporting small modifications for meeting standards, for meeting changing standards, for tuning of the circuit, and for use in different regions wherein standards differ. To this end, many 802.11 WiFi chip include a plurality of writeable registers for controlling different aspects of chip operation. Some typical registers control a clock, Phase Locked Loop, power level, bandwidth, etc.

An 802.11 ax integrated circuit, chip, is provided within a circuit for operating the chip at 501. The circuit comprises a data stream input port coupled to the digital data input port of the 802.11 ax integrated circuit, an analogue filter coupled to the RF output port of the 802.11 ax integrated circuit, and a register writing circuit for modifying contents of at least some registers.

At 502, in order to modify an 802.11 signal for down conversion, registers are modified to adjust the clock rate and bandwidth to fit a resulting channel bandwidth within a TVWS signal. The power level is also adjusted to better meet the RF requirements of the TVWS standard. Adjusting the PLL and power level allows for fine tuning of the resulting signal to better fit within a TVWS signal envelope once down converted.

Other aspects of the signal are also tunable through accessing other registers, when known, or through trial and error. Unfortunately, many 802.11 chip sets do not publish data relating to registers therein and as such, some effort is sometimes needed to discover the registers that are significant to tuning the chip. A method for determining registers are discussed hereinbelow.

Once some of the registers are determined, the chip's registers are written to adjust a bandwidth of data encoding within an output RF signal. The adjustment of the registers allows for a 6 MHz bandwidth signal to be encoded within the 22 MHz bandwidth channel of the output RF signal when the resulting TVWS signal is to encode a 6 Mhz channel, for example for a North American TVWS signal.

Once the registers have been written with new data, at 503, an output signal from the 802.11 ax chip is down converted and filtered and provided for analysis. The signal that results is evaluated against the TVWS standard to determine if it complies. When it fails to comply, at 504, the process returns to 502 and one of the filter and the values written to the registers is adjusted and the process repeats until the signal meets the TVWS standards. This iterative tuning allows for modification of the 802.11 chip operation without a complete knowledge of the register operations and specific effects. For example, a value that affects bandwidth is modified and when the results work within the TVWS standard once down converted, the present value is accepted. Because several registers are tuned, adjusting one may affect others and the iterative process continues until a balance between different values is achieved. Advantageously, once suitable register values are determined, at 505, they are reused until either the resulting signal once down converted fails to fall within the TVWS standard or until the TVWS standard changes. Alternatively, once suitable register values are discovered, then fine tuning of register values continues to try to find more optimal settings which are then reused.

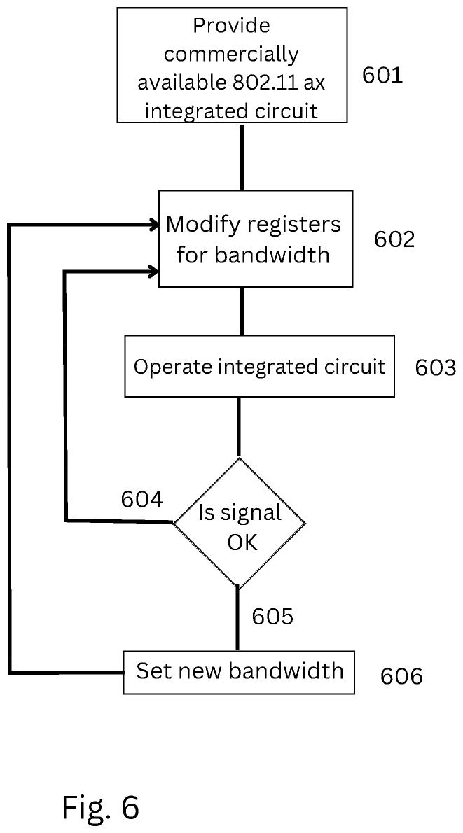

Referring to FIG. 6, shown is a simplified flow diagram of a method for modifying a commercially available 802.11 ax chipset. A networking standard implementation within an integrated circuit in the form of an 802.11 ax chip is provided at 601.

At 602, the integrated circuit's registers are written to adjust a bandwidth of data encoding within an output RF signal. The adjustment of the registers allows for selectively encoding of a 6 MHz bandwidth signal, a 12 MHz bandwidth signal, a 18 MHz bandwidth signal, and a 22 MHz bandwidth signal within the 22 MHz bandwidth channel of the output RF signal. Thus, for each bandwidth supported, register values are tuned in separate passes. The flow diagram of FIG. 6 is similar to that of FIG. 5, but now is performed for each of several bandwidths, selectable by a bandwidth selector signal for selecting the bandwidth of the encoded RF signal channel such that after down conversion, the down converted signal includes a data bandwidth that is as selected. For example, the selection signal rewrites the registers within the 802.11 ax chip to support a different data rate and channel bandwidth, when necessary. Typically, a selected bandwidth relates to available adjacent TVWS channels within which the data signal is to be transmitted.

Once again, since registers for generating each bandwidth signal need only be determined once and then can be repeated, once register settings are known, they are reusable. Once the registers are modified at 602, the integrated circuit is operated and its output RF signal is evaluated. Alternatively, the RF signal is filtered and down converted before evaluation. When the RF signal needs modification at 604 the process returns to modifying the registers. When the RF signal is acceptable, either because the filtered down converted signal meets TVWS standards or because the output RF signal is adjustable through changing the filter, then the process changes the bandwidth of the channel at 606 and returns to 602 for adjusting registers for a different bandwidth. In this way, register contents for each of a plurality of bandwidths are determined for the integrated circuit.

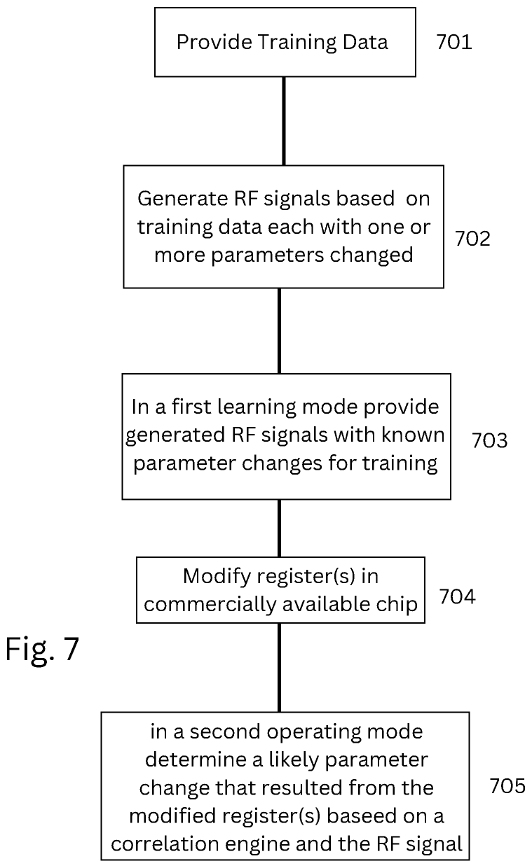

Referring to FIG. 7, shown is a learning process to determine registers within an 802.11 chip. Here, a series of parameters is changed within an 802.11 signal and for each parameter the resulting signal is determined and used as training data. The learning process learns what changing a PLL frequency, a clock rate, a power level and a bandwidth look like in a resulting generated signal. An 802.11 chip is provided to the learning process and the learning process is also provided data relating to writing registers within the 802.11 chip. The learning process is provided a means for writing to the chip registers, for example via a custom hardware interface.

The learning process works as follows: a correct output RF signal based on a given training data provided at 701. The correct RF output signal is then modified based on changes to parameters such as PLL, clock, bandwidth, etc. at 702. At 703, each of these changed RF signals are provided along with the cause to the learning process in order to weight values within a correlation engine.

The correlation engine is then used in an operating mode at 704 and 705 to discover register functions within the commercially available integrated circuit. Here, registers are modified at 704 and the resulting RF signal is provided to the correlation engine for extracting likely parameters modified by changing the register values at 705. This process continues until sufficient registers are mapped to their likely influence. Using correlation, for example, the learning process tries to determine which register affects which aspects of the resulting signal. This allows for mapping of relevant registers in some at least partially automated fashion for use in reprogramming the 802.11 ax chip in accordance with the methods of FIG. 5 or FIG. 6.

Once a register map is generated, the registers are reprogrammed through an iterative process for reprogramming registers, evaluating a resulting signal, and adjusting the reprogramming. This is continued until a resulting signal once down converted and filtered meets the TVWS signal standards. In some embodiments, this reprogramming is also performed by an automated process, for example a correlation engine in the form of a neural network. Alternatively, it is performed by a programmatic procedural process. Further alternatively, the register mapping process results in known registers with known effects and proper settings are predictively determined.

In some embodiments, this process is repeated for each bandwidth that is supported by the final TVWS device. When a single 6 Mhz channel is supported, it is performed one time. When multiple bandwidth channels are supported, it is performed multiple times. Alternatively, it is performed once and other changes needed are extrapolated from results of that one time.

Because of data rate, channel width, power level, and envelope requirements, as well as data encoding that transforms data received at the 802.11 ax chip into a stream of different digital bits, it is not straightforward to modify data provided to an 802.11 ax chip so as to affect the output signal as needed. Further, the nature of the data bandwidth transformation complicates matters more. Going from 22 MHz to 6 MHz in bandwidth is not simply a division by a whole number and as such, modifying data provided to the 802.11 ax chip does not seem like a possible solution to adjust an output data stream to meet the TVWS standard once down converted.

Another problem with trying to generate a TVWS compatible signal (once down converted) from a WiFi (802.11 ax) chip without redesigning the chip itself is that the channel within the TVWS band will change depending on available—unused—TV channels. This is not that significant since the down conversion moves the data from a first carrier frequency signal to a second other carrier frequency signals and the data bands within the TVWS band are presently standardised at 6 MHz.

802.11 is a very popular standard and is supported by millions of devices worldwide. The larger companies selling hardware, chips, in the space sell millions of those chips allowing the cost to benefit from scale. The design costs, testing costs, quality assurance costs, mask costs, and manufacturing costs are all spread out amongst millions of chips allowing the cost of each chip to be relatively low, well below the cost achievable through custom design of an integrated circuit for a small market application.

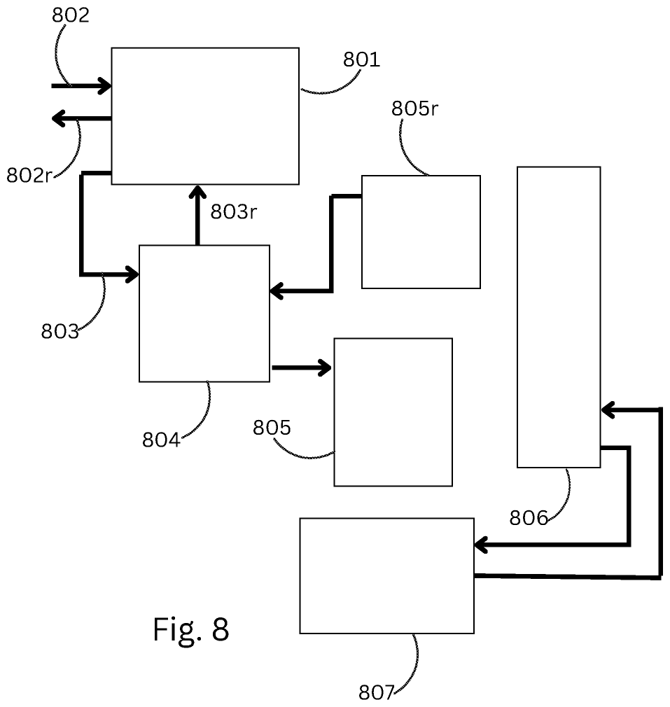

Referring to FIG. 8, shown is a block diagram of a circuit according to an embodiment. Here, an 802.11 ax chip 801 is coupled for receiving data 802 for transmission. The chip 801 encodes the data into a channel according to the 802.11 standard. The data is encoded with error detection/correction information, with addressing information for networking the data and with obfuscation for securing the data.

Unfortunately, an output RF signal 803 includes the data encoded in channels on a carrier signal outside the TVWS band and down converting the signal with up/down converter 804 results in a significant loss of information. For example, if the data is encoded within a 20 MHz band, then down converting the RF signal results in 20 MHz of bandwidth being squeezed into 6 MHz, which results in a loss of over ⅔ of the information and/or in inoperability of the resulting circuit.

As such, a transform is applied to at least one of the 802.11 encoding and the data provided for 802.11 ax encoding to ensure that a signal provided at an output thereof is for being down converted without a loss of data and without corruption of the data.

An industry standard 802.11 ax chip is programmatically modified by writing to its registers in order to adjust an output RF signal therefrom to have a correct bandwidth in its encoded data signal such that when down converted to the TVWS band, the data portion of the down converted signal reflects an appropriate data frequency and includes data encoded according to an approximation of the 802.11 standard.

The down converted signal is provided to filter 805 and then to amplifier 806 that amplifies the signal for driving load 807 in the form of an antenna. The circuit also works in receive mode where a signal excites the antenna 807. The signal is amplified by amplifier 806 and provided to receive filter 805r. The resulting signal is up converted by up/down converter 804 and provided to the 802.11 ax chip 801 as an RF input signal 803r thereto. The 802.11 ax chip 801 decodes data from the RF input signal 803r and provides data 802r at an output port thereof.

In an embodiment, a selector input value to the 802.11 ax chip selects between available bandwidth options −6 MHz for one channel in the TVWS band, 12 MHz for two adjacent channels in the TVWS band, 18 MHz for three adjacent channels in the TVWS band, and up to 24 MHz for four adjacent channels in the TVWS band. The selector value causes the 802.11 ax chip to encode data onto an RF carrier signal differently depending on a determined available data rate for a transmit signal. The available data rate is determined external to the chip based on TVWS adjacent unused channel availability and network load.

With each different channel width, a different amount of data is encoded within, for example, a 20 MHz band of the 802.11 chip output RF signal such that when it is down converted, the resulting RF carrier signal within the TVWS band has an indicated amount of data encoded thereon, the encoding according to an application of the 802.11 standard.

At a receiving end, setting the registers to values for receiving the generated signal is also needed. Thus, registers are set to same or different values for receiving an up converted TVWS signal and decoding said signal in accordance with the 802.11 ax standard. Typically, the generated signal and the up converted signal are at 2.4 GHz. In other embodiments, the generated signal and the up converted signal are at other frequencies supported by the 802.11 standard.

In another embodiment, a different chip supporting a different communication standard is reprogrammed and repurposed to encoding data for TVWS band transmission. Advantageously, the selection of a standard allows for data encoding supporting other layers of a communication stack. For example, when employing 802.11, error correction, security, channelization of data, routing of data, etc. are all part of the 802.11 standard and a resulting TVWS solution benefits because data, when received, is already encoded for communication networking, thereby eliminating a need to rebuild communication layers that are already inherent in the 802.11 standard. In an embodiment relying on an 802.11 chip, a digital data stream output from an output port of the 802.11 chip is often structured for provision to an ethernet network or alternatively, to a networking chip. Thus, using a standard mass-produced chip for a well-known and well tested protocol simplifies many layers of design.

Advantageously, if one mass produced chip set is poorly suited to reprogramming, another is selected. Since chips for known widely deployed standards are rarely the only chips available for those standards, a designer can choose a chip set based on available data, ease of programming, cost, effectiveness in a given circuit design, etc. Also, a designer has the option to choose a standard and a chip based on other features such as security, networking protocol compliance, networking protocol compatibility, protocol efficiency, and so forth.

In some embodiments, resulting RF signal parameters are modified differently to achieve compliance with the TVWS standard once an output RF signal is down converted and filtered. Instead of trying to adjust all parameters relating to bandwidth and frequency, which often times are not enough to meet a different standard because, for example, adjacent channel interference requirements are often different between standards, a bandwidth within a channel is adjusted to move encoded data more central to its transmission window such that at each end of channel data within a window there is a small buffer for limiting adjacent channel interference. By beginning channel data a bit later and ending it a bit earlier, a requirement for filtering is often significantly reduced. However, such an adjustment affects other aspects of data encoding and decoding and is typically only performed in conjunction with other compatible register changes.

In some embodiments, data is encoded within an 802.11 signal at a channel bandwidth above channel bandwidths typically supported by the 802.11 ax standard. For example, 802.11 typically transmits data within 22 MHz channels, but by modifying registers within some 802.11s chip it is possible to encode data within 24 MHz channels.

Numerous other embodiments may be envisaged without departing from the scope of the invention.

What is claimed is:

1. A method comprising:
selecting a first communication standard for supporting communication between at least one transmitter and at least one receiver, the first communication standard supporting a first data bandwidth;
determining an encoding of first data within a first signal in accordance with the first communication standard for providing first encoded data, the first encoded data for being down converted into a second signal within a TVWS band, the first encoded data having a bandwidth for having the first encoded data encoded within the second signal within the TVWS band in accordance with a TVWS standard;
selecting a commercially available integrated circuit for use with the first communication standard and for encoding data within an output signal in accordance with the first standard at the first data bandwidth;
modifying the commercially available integrated circuit by changing one of registers thereof, microcode thereof, or updatable codes stored therein for modifying encoding performed by the commercially available integrated circuit, the modified encoding for producing a modified output signal encoding data in accordance with the first standard but having encoded therein data at a second other lower bandwidth, the second other bandwidth other than a bandwidth supported by the first standard;
providing communication data to the commercially available integrated circuit;
encoding the communication data within an output signal of the modified commercially available integrated circuit to provide encoded communication data in accordance with the first standard but having encoded therein the encoded communication data at the second other lower bandwidth;
providing the output signal from the commercially available integrated circuit to a down converter;
down converting the output signal to a second band within the TVWS band to provide a first down converted signal, the first down converted signal having the encoded communication data encoded therein; and
providing the first down converted signal for wireless transmission.

2. A method according to claim 1 wherein the first bandwidth is 22 MHz.

3. A method according to claim 2 wherein the second lower bandwidth is one of 6 Mhz, 7 MHz, and 8 MHz.

4. A method according to claim 3 wherein the second lower bandwidth is 6 MHz.

5. A method according to claim 2 wherein the second lower bandwidth is a multiple of one of 6 Mhz, 7 MHz, and 8 MHz.

6. A method according to claim 2 wherein the second lower bandwidth is selected dependent upon a multiple of one of 6 Mhz, 7 MHz, and 8 MHz.

7. A method according to claim 6 wherein the second lower bandwidth is selected dependent upon a multiple of 6 Mhz.

8. A method according to claim 2 wherein the second other lower bandwidth is determined based on available adjacent data transmission channels within the TVWS band, the determined second other lower bandwidth is provided to the commercially available integrated circuit and an encoding is performed in dependence upon the determined second other lower bandwidth for encoding data within the encoded signal at the first bandwidth, the encoded data encoded for supporting the second other lower bandwidth when down converted.

9. A method according to claim 1 wherein the commercially available integrated circuit supports a network layer, comprising encoding networking data within the output signal.

10. A method according to claim 1 wherein the commercially available integrated circuit supports 802.11 ax.

11. A circuit comprising:
a commercially available integrated circuit for use with a first communication standard and for encoding data within an output signal in accordance with the first standard and having a first data bandwidth, the commercially available integrated circuit modified by changing one of registers thereof, microcode thereof, or updatable codes stored therein for modifying encoding performed by the commercially available integrated circuit, the modified commercially available integrated circuit for producing a modified output signal encoded in accordance with the first standard but having encoded therein data at a second other lower bandwidth, the second other bandwidth other than a bandwidth supported by the first standard.

12. A circuit according to claim 11 comprising a down converter for receiving an output RF signal from the commercially available integrated circuit and for provided a down converted signal within the TVWS band to an amplifier for amplifying the down converted signal and for driving an antenna with the amplified down converted signal.

13. A circuit according to claim 11 comprising a down converter for receiving an output RF signal from the commercially available integrated circuit and for down converting same to provide an output down converted signal within the TVWS band to an amplifier for driving an antenna with an amplified version of the output down converted signal.

14. A circuit according to claim 11 wherein the commercially available integrated circuit comprises an input port for receiving a selector signal, the selector signal for selecting between different encoding bandwidths for encoding data within the RF output signal.

15. A method comprising:
selecting a first communication standard for supporting communication between at least one transmitter and at least one receiver, the first communication standard supporting a first data bandwidth;
determining an encoding of first data within a first signal in accordance with the first communication standard for providing first encoded data, the first encoded data for being down converted into a second signal within a TVWS band, the first encoded data having a bandwidth for having the first encoded data encoded within the second signal within the TVWS band in accordance with a TVWS standard;
selecting a commercially available integrated circuit for use with the first communication standard and for encoding data within an output signal in accordance with the first standard at the first data bandwidth;
modifying the commercially available integrated circuit by changing one of registers thereof, microcode thereof, or updatable codes stored therein for modifying encoding performed by the commercially available integrated circuit, the modified encoding for producing a modified output signal encoding data in accordance with the first standard but having encoded therein data at a second other lower bandwidth, the second other bandwidth other than a bandwidth supported by the first standard;
providing communication data to the commercially available integrated circuit;
encoding the communication data within an output signal of the modified commercially available integrated circuit to provide encoded communication data in accordance with the first standard but having encoded therein the encoded communication data at the second other lower bandwidth;
providing the output signal from the commercially available integrated circuit to a down converter;
down converting the output signal to a second band within the TVWS band to provide a first down converted signal, the first down converted signal having the encoded communication data encoded therein; and
providing the first down converted signal for wireless transmission.

16. A method comprising:
receiving a TVWS signal comprising data within a TVWS band;
upconverting the received TVWS signal to another protocol band outside the TVWS band;
providing the up converted signal to a suitably programmed integrated circuit supporting the another protocol for decoding data within the upconverted signal; and
Providing at an output port of the integrated circuit a data signal comprising the decoded data.

17. A method according to claim 16 wherein the suitably programmed integrated circuit has data stored therein for supporting decoding of the upconverted signal, the suitably programmed integrated circuit unable to function as intended with signals according to the another standard.

18. A circuit comprising:
an integrated circuit for supporting a first protocol for decoding data within an RF signal according to the first protocol, the integrated circuit reprogrammed to form a suitably programmed integrated circuit for receiving an upconverted RF signal upconverted from a frequency band of another protocol and other than of the first protocol and for decoding data within the upconverted RF signal, the integrated circuit comprising an output port for providing an output data signal comprising the decoded data thereon, wherein the suitably programmed integrated circuit is other than for supporting decoding of RF signals according to the first standard.
